(19) United States
(12) Patent Application Publication
(10) Pub. No.: US 2018/0120218 A1
(43) Pub. Date: May 3, 2018

(54) METHOD, SYSTEM AND OPTICAL SENSOR ASSEMBLY FOR OPTICALLY INSPECTING AN OBJECT LOCATED IN AN ENVIRONMENT HAVING AIRBORNE PARTICULATE MATTER OR VAPOR CAPABLE OF COATING AN OPTICALLY TRANSPARENT WINDOW OF A SENSOR OF THE ASSEMBLY

(71) Applicant: Liberty Reach Inc., Clearwater, ID (US)

(72) Inventors: David D. Shultis, Ann Arbor, MI (US); Alexander J. Pageau, Ann Arbor, MI (US); G. Neil Haven, Clearwater, ID (US)

(21) Appl. No.: 15/341,025

(22) Filed: Nov. 2, 2016

(51) Int. Cl. G01N 21/15; G01B 11/00

(52) U.S. Cl. CPC G01N 21/15; G01N 2021/151; G01B 11/002

(57) ABSTRACT

A method, system and optical sensor assembly for optically inspecting an object located in an environment having airborne particulate matter or vapor capable of coating an optically transparent window of an optical sensor of the assembly are provided. The method includes creating a positive dynamic boundary layer of air in front of and immediately adjacent an outer surface of the window. The layer of air has a pressure sufficient to protect the window from undesirable accumulation of the particulate matter or droplets of the vapor on the outer surface, thereby allowing the sensor to have an unobstructed view of the object.

### TECHNICAL FIELD

At least one embodiment of the invention generally relates to methods, systems and optical sensor assemblies for optically inspecting objects and, in particular, to such methods, systems and assemblies which can inspect objects located in environments which have airborne particulate matter or vapor capable of coating optically transparent windows of sensors of the assemblies.

### Overview

In some automated vision applications small, airborne particulate matter (such as atomized paint droplets) may cover the sensor optical glass face and obstruct optical sensor measurements including 3-D sensor measurements. An example of the problem can be stated in bullet format as follows:
small particulate matter easily coats sensors in industrial working environments rendering them non-functional;
   paint ˜20 um droplet particle size (diameter)
   100 mm/sec droplet velocities at position of sensors (˜2 meters from spray gun and surface)
   cleaning the sensor optical glass face regularly may expose personnel to dangerous environments and incur additional expenses or require assembly line stoppage—all of which are unfavorable.
List of possible methods to create a housing to protect sensor from particulates includes:
   shutters—prone to electromechanical failure
   protective shields and skirts—only partial protection
   revolving optical glass covers—prone to electromechanical failure
   self-cleaning glass covers—prone to electromechanical failure

Because the particulates may be airborne continuously during the manufacturing processes, use of mechanical gating methods, such as shutters, is not practical.

### SUMMARY OF EXAMPLE EMBODIMENTS

An object of at least one embodiment of the invention is to provide a method, system and optical sensor assembly for optically inspecting an object located in an environment having airborne particulate matter or vapor capable of coating an optically transparent window of an optical sensor of the assembly.

In carrying out the above object and other objects of at least one embodiment of the invention, a method of optically inspecting an object located in an environment having airborne particulate matter or vapor capable of coating an optically transparent window of an optical sensor. is provided. The method includes creating a positive dynamic boundary layer of air in front of and immediately adjacent an outer surface of the window. The layer of air has a pressure sufficient to protect the window from undesirable accumulation of the particulate matter or droplets of the vapor on the outer surface, thereby allowing the sensor to have an unobstructed view of the object.

The step of creating may include the steps of pressurizing air in an enclosed space adjacent the sensor and directing air flow from the space over the outer surface of the window to create the boundary layer.

The step of creating may include the step of blowing air over the outer surface of the window from a plurality of spaced locations about a periphery of the window to create the boundary layer.

The air may be dry to hinder condensation of the vapor on the window.

The method may further include shielding the window from the sides of the window.

The window may be double-paned.

The window may be optically transparent to projected and received visible and near-visible radiation.

The material of the window may be transparent to light having a wavelength in a range of 400 nanometers to 850 nanometers.

The particulate matter may be paint droplets.

The vapor may be water vapor.

Further in carrying out the above object and other objects of at least one embodiment of the present invention, a system for optically inspecting an object located in an environment having airborne particulate matter or vapor capable of coating an optically transparent window of a sensor is provided. The system includes an automatic machine, an air supply and an optical sensor assembly mounted on the machine to move therewith. The assembly has a sensor with an optically transparent window and a hollow protective enclosure secured around the window. The enclosure is fluidly coupled to the air supply. The enclosure is open at one end to allow the sensor to have an unobstructed view of the object. The enclosure includes a plurality of spaced gas vent ports to direct air from within the enclosure over an outer surface of the window to create a protective dynamic boundary layer of air in front of and immediately adjacent to the outer surface of the window. The layer of air has a pressure sufficient to protect the window from undesirable accumulation of the particulate matter or droplets of the vapor on the outer surface of the window, thereby allowing the sensor to have an unobstructed view of the object.

The enclosure may include a plenum for receiving pressurized air and a plurality of gas vent ports to direct air flow from the plenum over the outer surface of the window.

The size and number of gas vent ports may be empirically determined.

The air may be dry to hinder condensation of the vapor on the window.

The enclosure may have a frustum shape to shield the window from the sides of the window.

The window may be double-paned.

The window may be optically transparent to projected and received visible and near-visible radiation.

The material of the window may be transparent to light having a wavelength in a range of 400 nanometers to 850 nanometers.

The particulate matter may be paint droplets.

The vapor may be water vapor.

Still further in carrying out the above object and other objects of at least one embodiment of the invention, an optical sensor assembly for optically inspecting an object located in an environment having airborne particulate matter or vapor capable of coating an optically transparent window of a sensor of the assembly is provided. The assembly includes the optical sensor having the optically transparent window for optically inspecting objects located in the environment and a hollow protective enclosure secured about the window and adapted to be fluidly coupled to an air supply. The enclosure is open at one end to allow the sensor to have an unobstructed view of the object. The enclosure has a plurality of spaced gas ports to direct pressurized air from within the enclosure over an outer surface of the window to create a protective dynamic boundary layer of air in front of and immediately adjacent to the outer surface of the window. The layer of air has a pressure sufficient to protect the window from undesirable accumulation of the particulate matter or droplets of the vapor on the window while allowing the sensor to have an unobstructed view of the object.

The enclosure may include a plenum for receiving pressurized air and a plurality of gas vent ports to direct air flow from the plenum over the outer surface of the window.

The size and number of gas vent ports may be determined empirically.

The air may be dry to hinder condensation of the vapor on the window.

The enclosure may have a frustum shape to shield the window from the sides of the window.

The window may be double-paned.

The window may be optically transparent to projected and received visible and near-visible radiation.

The material of the window may be transparent to light having a wavelength in a range of 400 nanometers to 850 nanometers.

The particulate matter may be paint droplets.

The vapor may be water vapor.

The sensor may be a 3-D sensor.

Other technical advantages will be readily apparent to one skilled in the art from the following figures, descriptions and claims. Moreover, while specific advantages have been enumerated, various embodiments may include all, some, or none of the enumerated drawings.

### BRIEF DESCRIPTION OF THE DRAWINGS

FIG. 1 is a schematic view showing the flow of a free stream of air over a surface to create a protective boundary layer of air over the surface;

FIG. 2 is a perspective view, partially broken away, of an optical sensor mounted on the distal end of a robot arm wherein an optically transparent window of the sensor is shown;

FIG. 3 is a block diagram of a 3-D or depth sensor constructed in accordance with at least one embodiment of the present invention and being used in an industrial working environment such as a paint spray booth;

FIG. 4 is a front perspective view of an optical sensor assembly including an optical sensor and a hollow protective enclosure secured about a pair of optical windows of the sensor;

FIG. 5 is a top perspective view of the assembly of FIG. 4;

FIG. 6 is a side perspective view of the assembly of FIGS. 4 and 5 and further showing an air supply coupled to the enclosure; and

FIG. 7 illustrates design details of an exemplary embodiment of a plenum-type skirt or enclosure of the assembly.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

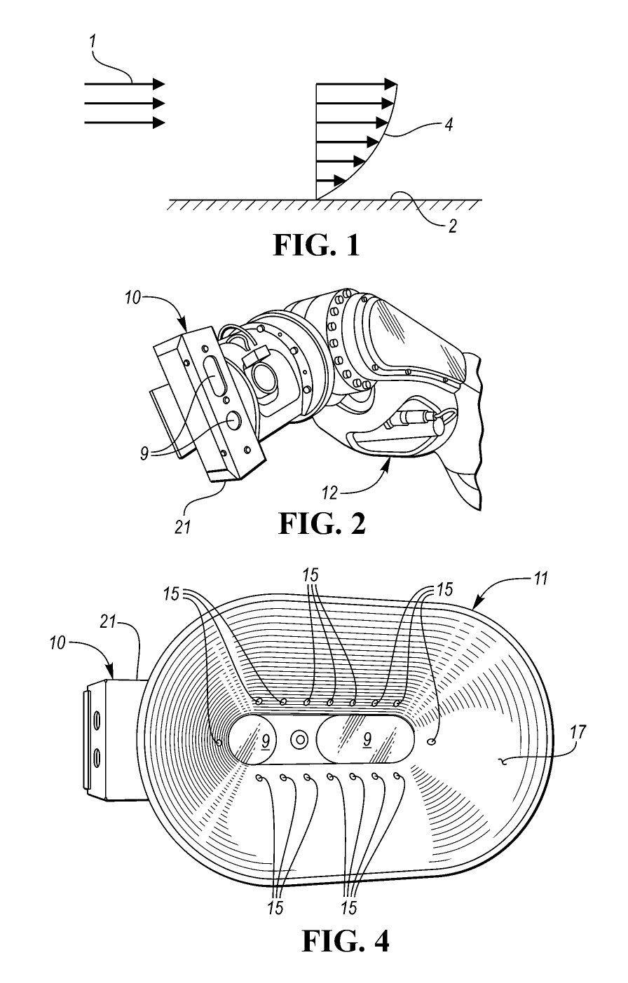

As shown in FIG. 1, when the flow of a free stream 1 of air is introduced and directed past a surface 2, the layer immediately adjacent to the surface 2 adheres to it, or the tangential velocity at the surface 2 is zero. In the transition region near the surface 2, which is called the boundary layer 4, the velocity increases from zero to the velocity of the stream 1.

Within the boundary layer 4, adjacent layers of fluid will be traveling at different velocities. The different velocities are the result of shearing stresses that are produced in the fluid. The shearing stresses are produced by the fluid's viscosity. Outside the boundary layer 4—in the freestream 1—all fluid will be traveling at the same speed and the effect of the fluid's viscosity will be negligible.

Referring now to FIGS. 4-6, a solution to at least one of the above-noted problems (as only provided by the present invention) is to inhibit foreign particulates from reaching an optical face or windows 9 of a 3-D or depth sensor, generally indicated at 10, by creating a protective dynamic boundary layer of air as described above. Clean positive air pressure around the optical face or windows 9 of the optical sensor 10 is provided by a frustom-shaped enclosure 11 for the sensor 10. The enclosure 11 comprises a plenum-type hollow skirt which surrounds the face or windows 9 of the sensor 10, but does not occlude sensor vision. Pressurized air is supplied to a plenum (located in the base 13 of the skirt 11) from an air supply via an air hose 19 and a coupling 18, which, in turn, provides air via nozzles or ports 15 to the hollow cavity 17 defined by the frustum skirt 11. The flow of this air creates a dynamic boundary layer (similar to the boundary layer 4 of FIG. 1) that significantly inhibits foreign particular contamination on the face or windows 9 of the sensor 10 through mass air displacement, limiting turbulent flow, and blocking immediate particulate access to the sensor optical face 9.

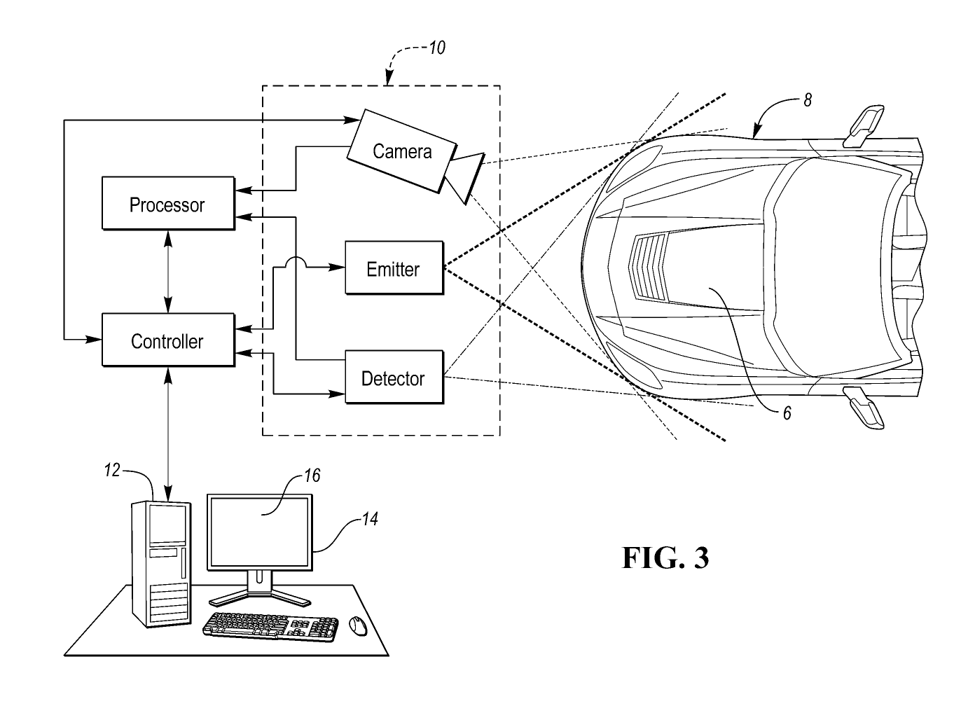

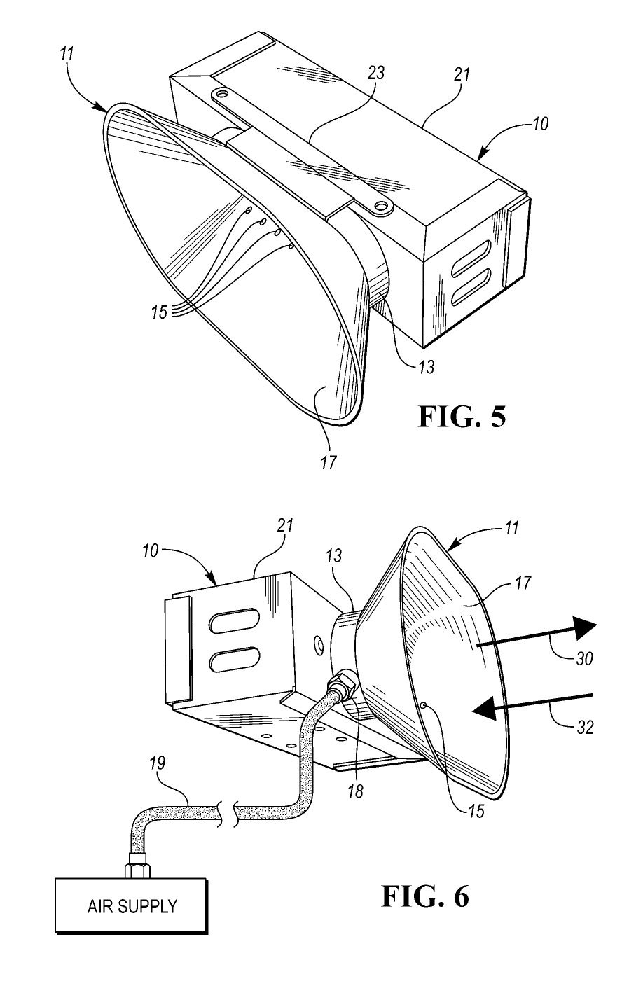

The system of at least one embodiment of the present invention includes one or more 3-D or depth sensors such as 2.5D volumetric or 2-D/3-D hybrid sensors, one of which is generally indicated at 10 in FIGS. 2-6. FIG. 2 shows a housing or container 21 of the sensor 10 mounted on the distal end of a robot arm 12. The skirt 11 is mounted on the container 21 via a mounting bracket 23 (FIG. 5). FIG. 3 shows the sensor 10 positioned near a vehicular body 8 including a hood 6 in an environment which has airborne particulate matter (such as paint droplets in a paint spray booth, or vapor such as water vapor) capable of coating the optically transparent windows 9 of the sensor 10.

The sensor technology described herein is sometimes called “3-D” because it measures X, Y and Z coordinates of objects within a scene. This can be misleading terminology. Within a given volume these sensors only obtain the X, Y and Z coordinates of the surfaces of objects; the sensors are not able to penetrate objects in order to obtain true 3-D cross-sections, such as might be obtained by a CAT scan of the human body. For this reason, the sensors are often referred to as 2½-D sensors which create 2½ dimensional surface maps to distinguish them from true 3-D sensors which create 3-D tomographic representations of not just the surface, but also the interior of an object.

In spite of this distinction between 2.5-D and 3-D sensors, people in the vision industry will often speak of 2.5-D sensors as 3-D sensors. The fact that “3-D Vision” sensors create 2.5-D surface maps instead of 3-D tomographs is implicit.

Referring to FIG. 3, preferably these sensors each comprise a near-infrared pattern projector or emitter, a near-infrared camera or detector and a visible light monochromatic or color camera. The near infrared pattern is projected by the emitter onto the surface of the vehicle and is read by the detector along with the information from the visible light camera. In other words, the laser projector operates in the near infrared by means of diffractive optical elements to project several 10's of thousands of laser pencils or beams onto a scene to be analyzed. The infrared camera analyzes the infrared scene to locate the intersections of the laser pencils with the scene and then uses geometry to calculate the distance to objects in the scene. The visible light camera in a preferred embodiment is used to associate a color or monochrome intensity to each portion of the analyzed image.

The IR pattern emitter may comprise of an infrared laser diode emitting at 830 nm and a series of diffractive optics elements. These components work together to create a laser “dot” pattern. The laser beam from the laser diode is shaped in order to give it an even circular profile then passed through two diffractive optics elements. The first element creates a dot pattern containing dots, the second element multiplies this dot pattern into a grid. When the infrared pattern is projected on a surface, the infrared light scattered from the surface is configured to be sensitive in the neighborhood of 830 nm.

In addition to the IR sensor, there may be an RGB sensor or camera configured to be sensitive in the visible range, with a visible light band-pass filter operative to reject light in the neighborhood of 830 nm. During operation, the IR sensor is used to calculate the depth of an object and the RGB sensor is used to sense the object's color and brightness. This provides the ability to interpret an image in what is traditionally referred to as two and a half dimensions. It is not true 3-D due to the sensor only being able to detect surfaces that are physically visible to it (i.e., it is unable to see through objects or to see surfaces on the far side of an object).

Alternatively, the 3-D or depth sensor 10 may comprise light-field, laser scan, time-of-flight or passive binocular sensors, as well as active monocular and active binocular sensors.

Preferably, the 3-D or depth sensor 10 of at least one embodiment of the invention measure distance via massively parallel triangulation using a projected pattern (a “multi-point disparity” method). The specific types of active depth sensors which are preferred are called multipoint disparity depth sensors.

“Multipoint” refers to the laser projector which projects thousands of individual beams (aka pencils) onto a scene. Each beam intersects the scene at a point.

“Disparity” refers to the method used to calculate the distance from the sensor to objects in the scene. Specifically, “disparity” refers to the way a laser beam's intersection with a scene shifts when the laser beam projector's distance from the scene changes.

“Depth” refers to the fact that these sensors are able to calculate the X, Y and Z coordinates of the intersection of each laser beam from the laser beam projector with a scene.

“Passive Depth Sensors” determine the distance to objects in a scene without affecting the scene in any way; they are pure receivers.

“Active Depth Sensors” determine the distance to objects in a scene by projecting energy onto the scene and then analyzing the interactions of the projected energy with the scene. Some active sensors project a structured light pattern onto the scene and analyze how long the light pulses take to return, and so on. Active depth sensors are both emitters and receivers.

For clarity, the sensor 10 is preferably based on active monocular, multipoint disparity technology as a “multipoint disparity” sensor herein. This terminology, though serviceable is not standard. A preferred monocular (i.e., a single infrared camera) multipoint disparity sensor is disclosed in U.S. Pat. No. 4,493,496. A binocular multipoint disparity sensor, which uses two infrared cameras to determine depth information from a scene, is also preferred.

Multiple volumetric sensors are placed in key locations around and above the vehicle. Each of these sensors typically captures hundreds of thousands of individual points in space. Each of these points has both a Cartesian position in space and an associated RGB color value. Before measurement, each of these sensors is registered into a common coordinate system. This gives the present system the ability to correlate a location on the image of a sensor with a real world position. When an image is captured from each sensor, the pixel information, along with the depth information, is converted by a computer 12 into a collection of points in space, called a “point cloud”.

A point cloud is a collection of data representing a scene as viewed through a “vision” sensor. In three dimensions, each datum in this collection might, for example, consist of the datum's X, Y and Z coordinates along with the Red, Green and Blue values for the color viewed by the sensor 10 at those coordinates. In this case, each datum in the collection would be described by six numbers. To take another example: in two dimensions, each datum in the collection might consist of the datum's X and Y coordinates along with the monotone intensity measured by the sensor 10 at those coordinates. In this case, each datum in the collection would be described by three numbers.

The computer 12 of FIG. 3 controls a controller which, in turn, controls a processor, the camera, the emitter and the detector of the sensor 10.

At least one embodiment of the present invention uses hybrid 2-D/3-D sensors 10 to measure color, brightness and depth at each of hundreds of thousands of pixels per sensor 10. The collective 3-D “point cloud” data may be presented on a screen 16 of a display 14 as a 3-D graphic.

The field of view of each 2-D/3-D sensor 10 can be as wide as several meters across, making it possible for the user to see a hinged part such as a door or the hood 6 relative to the vehicle body 8 in 3-D. The graphic on the screen 16 may look like the 3-D part the user sees in the real world.

In summary, at least one embodiment of the invention provides aerodynamic boundary layer control via a positive air displacement, plenum-type frustum skirt 11. At least one embodiment of the invention provides:
a mass flow of air away from the sensor face 9 as indicated by arrow 30 in FIG. 6;
achieves negative velocities of paint particles with respect to the sensor face 9;
plenum chamber provides positive air pressure to frustum skirt 11; and
frustum nozzle or port size and number empirically determined from experiments.

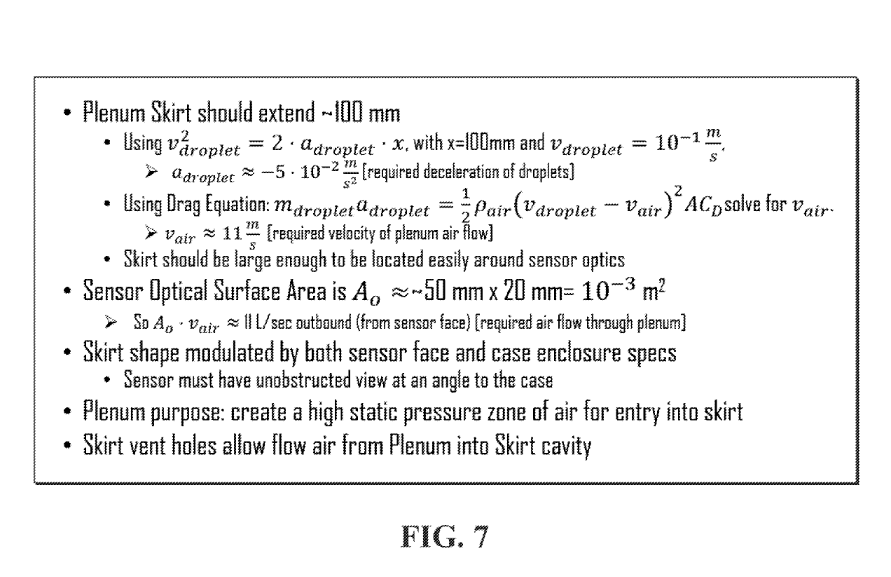

At least one embodiment of the invention meets one or more of the following design specifications:
easy to manufacture;
low cost;
easy to mount;
small footprint;
block 100 mm/sec paint velocity in the direction of paint spray, as indicated by arrow 32 in FIG. 6, from striking optical sensor face 9; (FIG. 7 illustrates design details of an exemplary embodiment of a plenum-type skirt 11 or enclosure);
block paint from pooling or running down the sensor face 9;
no electromechanical points of failure;
dry air flow helps avoid condensation; and
easy to clean; easy to replace.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of optically inspecting an object located in an environment having airborne particulate matter or vapor capable of coating an optically transparent window of an optical sensor, the method comprising:
creating a positive dynamic boundary layer of air in front of and immediately adjacent an outer surface of the window, the layer of air having a pressure sufficient to protect the window from undesirable accumulation of the particulate matter or droplets of the vapor on the outer surface, thereby allowing the sensor to have an unobstructed view of the object.

2. The method as claimed in claim 1, wherein the step of creating includes the steps of pressurizing air in an enclosed space adjacent the sensor and directing air flow from the space over the outer surface of the window to create the boundary layer.

3. The method as claimed in claim 1, wherein the step of creating includes the step of blowing air over the outer surface of the window from a plurality of spaced locations about a periphery of the window to create the boundary layer.

4. The method as claimed in claim 3, wherein the air is dry to hinder condensation of the vapor on the window.

5. The method as claimed in claim 1, further comprising shielding the window from the sides of the window.

6. The method as claimed in claim 1, wherein the window is double-paned.

7. The method as claimed in claim 1, wherein the sensor is a 3-D sensor and wherein the window is optically transparent to projected and received visible and near-visible radiation.

8. The method as claimed in claim 1, wherein the material of the window is transparent to light having a wavelength in a range of 400 nanometers to 850 nanometers.

9. The method as claimed in claim 1, wherein the particulate matter is paint droplets.

10. The method as claimed in claim 1, wherein the vapor is water vapor.

11. A system for optically inspecting an object located in an environment having airborne particulate matter or vapor capable of coating an optically transparent window of a sensor, the system comprising:
an automatic machine;
an air supply; and
an optical sensor assembly mounted on the machine to move therewith, the assembly including a sensor having an optically transparent window and a hollow protective enclosure secured around the window and fluidly coupled to the air supply, the enclosure being open at one end to allow the sensor to have an unobstructed view of the object, the enclosure including a plurality of spaced gas vent ports to direct air from within the enclosure over an outer surface of the window to create a protective dynamic boundary layer of air in front of and immediately adjacent to the outer surface of the window, the layer of air having a pressure sufficient to protect the window from undesirable accumulation of the particulate matter or droplets of the vapor on the outer surface of the window, thereby allowing the sensor to have an unobstructed view of the object.

12. The system as claimed in claim 11, wherein the enclosure includes a plenum for receiving pressurized air and a plurality of gas vent ports to direct air flow from the plenum over the outer surface of the window.

13. The system as claimed in claim 12, wherein the size and number of gas vent ports are empirically determined.

14. The system as claimed in claim 11, wherein the air is dry to hinder condensation of the vapor on the window.

15. The system as claimed in claim 11, wherein the enclosure has a frustum shape to shield the window from the sides of the window.

16. The system as claimed in claim 11, wherein the window is double-paned.

17. The system as claimed in claim 11, wherein the sensor is a 3-D sensor and wherein the window is optically transparent to projected and received visible and near-visible radiation.

18. The system as claimed in claim 11, wherein the material of the window is transparent to light having a wavelength in a range of 400 nanometers to 850 nanometers.

19. The system as claimed in claim 11, wherein the particulate matter is paint droplets.

20. The system as claimed in claim 11, wherein the vapor is water vapor.

21. An optical sensor assembly for optically inspecting an object located in an environment having airborne particulate matter or vapor capable of coating an optically transparent window of a sensor of the assembly, the assembly comprising:
an optical sensor having an optically transparent window for optically inspecting objects located in the environment; and
a hollow protective enclosure secured about the window and adapted to be fluidly coupled to an air supply, the enclosure being open at one end to allow the sensor to have an unobstructed view of the object, the enclosure including a plurality of spaced gas ports to direct pressurized air from within the enclosure over an outer surface of the window to create a protective dynamic boundary layer of air in front of and immediately adjacent to the outer surface of the window, the layer of air having a pressure sufficient to protect the window from undesirable accumulation of the particulate matter or droplets of the vapor on the window while allowing the sensor to have an unobstructed view of the object.

22. The assembly as claimed in claim 21, wherein the enclosure includes a plenum for receiving pressurized air and a plurality of gas vent ports to direct air flow from the plenum over the outer surface of the window.

23. The assembly as claimed in claim 22, wherein the size and number of gas vent ports are determined empirically.

24. The assembly as claimed in claim 21, wherein the air is dry to hinder condensation of the vapor on the window.

25. The assembly as claimed in claim 21, wherein the enclosure has a frustum shape to shield the window from the sides of the window.

26. The assembly as claimed in claim 21, wherein the window is double-paned.

27. The assembly as claimed in claim 21, wherein the sensor is a 3-D sensor and wherein the window is optically transparent to projected and received visible and near-visible radiation.

28. The assembly as claimed in claim 21, wherein the material of the window is transparent to light having a wavelength in a range of 400 nanometers to 850 nanometers.

29. The assembly as claimed in claim 21, wherein the particulate matter is paint droplets.

30. The assembly as claimed in claim 21, wherein the vapor is water vapor.
